(19) United States
(12) Patent Application Publication
(10) Pub. No.: US 2023/0046784 A1
(43) Pub. Date: Feb. 16, 2023

(54) METHOD FOR WORKING A WORKPIECE WITH TWO TOOTHINGS, POSITIONING DEVICE FOR DETERMINING A REFERENCE ROTATIONAL ANGLE POSITION OF THE WORKPIECE AND POWER TOOL WITH SUCH A POSITIONING DEVICE

(71) Applicant: REISHAUER AG, Wallisellen (CH)

(72) Inventors: André EGER, Wallbach (CH); Ronald JAKOB, Gutenswil (CH)

(73) Assignee: REISHAUER AG, Wallisellen (CH)

(21) Appl. No.: 17/794,444

(22) PCT Filed: Jul. 21, 2020
(86) PCT No.: PCT/EP2020/070542

§ 371 Date: Jul. 21, 2022

(30) Foreign Application Priority Data
Jan. 22, 2020 (CH) 00065/20

(51) Int. Cl. B23F 5/04; B23F 23/12

(52) U.S. Cl. CPC B23F 5/04; B23F 23/1218

(57) ABSTRACT

In a method of machining a workpiece (60) having first and second gearings (61, 62), a reference tooth structure of the first gearing (61) is identified. The reference tooth structure is then measured with a reference measuring device (140) to determine a reference rotational angular position of the workpiece. Subsequently, the second gearing (62) is machined in such a way that the second gearing obtains a rotational angular position which is in a predetermined relationship to the determined reference rotational angular position.

### TECHNICAL FIELD

The present invention relates to a method of machining a workpiece having first and second gearings, to a positioning device for use in such a method, and to a machine tool suitable for carrying out the method.

### PRIOR ART

In gear manufacturing, workpieces are occasionally used that have two or more gearings on a common shaft. Such workpieces are also referred to as double gearings or twin gearings in the following. They are often used, for example, in electric drives.

The workpieces are often first pre-machined with a soft machining process and then hardened. This is followed by a hard fine machining process. In hard fine machining, the problem often arises of machining one of the two gearings in such a way that this gearing is aligned exactly in a predetermined way with the other gearing (hereinafter referred to as a reference gearing) with regard to its rotational angular position. For example, it is often specified that a tooth structure, e.g. a tooth or a tooth gap, of the gearing to be machined should be exactly aligned with a specified reference tooth structure of the reference gearing.

It is known to determine the rotational angular positions of tooth structures (e.g. tooth tips or tooth gaps) of a gearing with a non-contact meshing sensor. The meshing sensor may be an inductive or capacitive sensor. The meshing sensor determines the positions of the tooth structures without contact while the workpiece rotates past it.

However, conventional meshing sensors are often unable to determine the rotational angular positions of tooth structures with sufficient precision to ensure that two gaps in the two tooth structures are aligned with the desired precision. This is particularly true if the gearings are provided with a chamfer at the transition between the tooth flank and the tooth tip, i.e. with a bevel or rounding. The chamfer makes it difficult for the meshing sensor to detect the positions of the tooth structures. Moreover, it is not always ensured that the chamfer is identical for all teeth.

DE 20 2017 105 125 U1 discloses a gear measuring instrument with two measuring devices. One of the two measuring devices is a touch probe, the other a non-contact sensor device. The first measuring device is movable along a measuring axis. The second measuring device can be moved in a “piggyback” arrangement relative to the first measuring device between two positions. This document does not deal with the problem of double gearings.

EP 3 518 058 A1 discloses a method for the automatic positioning of a toothed workpiece that has a machine-readable, workpiece-specific marking. The marking is detected, and on this basis an actual position of the workpiece is determined. The workpiece is then brought into a target position. The document does not deal with the problem of double gearings.

### SUMMARY OF THE INVENTION

It is an object of the present invention to provide a method for machining a workpiece with at least two gearings, which allows one of the two gearings to be machined in such a way that this gearing is precisely aligned with the other gearing in a predetermined manner with respect to its rotational angular position. The method should also enable precise alignment even if the gearings have a chamfer.

This problem is solved by a method according to claim 1. Further embodiments are provided in the dependent claims.

A method for machining a workpiece with first and second gearings is provided. The workpiece is clamped to rotate around a workpiece axis. The method comprises:
identifying at least one reference tooth structure of the first gearing with a reference identification device;
measuring the reference tooth structure with a reference measuring device to determine a reference rotational angular position of the workpiece; and
machining the second gearing with a machining tool in such a way that the second gearing obtains a rotational angular position which is in a predetermined relationship to the determined reference rotational angular position.

Accordingly, first, at least one reference tooth structure (e.g. a reference tooth or a reference tooth gap) of the first gearing (reference gearing) is uniquely identified. The reference tooth structure is then precisely measured. This allows a reference rotational angular position of the workpiece to be determined quickly and with high precision. Optionally, several reference tooth structures of the reference gearing may be measured in order to determine the reference rotational angular position particularly precisely. The second gearing can now be machined on the basis of the reference rotational angular position of the reference gearing determined in this way. This ensures that the second gearing receives a rotational angular position as a result of the machining process which is in the desired relationship to the determined reference rotational angular position with high precision. For example, it can be ensured that, after machining, at least one tooth structure of the second gearing is exactly aligned with at least one predetermined reference tooth structure of the first gearing or has a predetermined difference in the rotational angle to this reference tooth structure. In contrast to usual practice, it is not the position of the tooth structures of the second gearing that determines how this gearing is machined, but the position of the tooth structures of the first gearing.

The machining of the second gearing may be carried out, e.g., by a generating machining process, in particular by a generating gear grinding process, a gear skiving process or a hob honing process. In this case, the rolling coupling angle for the generating machining process is preferably determined using the previously determined reference rotational angular position of the workpiece. This means that a rotational angular position of the gearing to be machined is not determined for defining the rolling coupling angle, as would be usually the case, but the rolling coupling angle is determined on the basis of the position of the previously measured reference tooth structure of the reference gearing. However, other machining methods other than generating machining methods are also conceivable, e.g. discontinuous methods such as profile grinding.

In advantageous embodiments, the workpiece has at least one marking, and the reference identification device comprises a contactless marking detection device. The identification of the at least one reference tooth structure of the first gearing may then include:
detecting the at least one marking on the workpiece with the marking detection device; and
identifying the at least one reference tooth structure of the first gearing on the basis of the detected marking.

The marking may be any type of marking that can be detected without contact. For example, the marking may be formed by a frontal bore in a portion of the workpiece, wherein the bore may form a blind hole or a through-hole. The bore may be open or filled with a filling material. The marking may also be formed by an engraving, a chamfer, a projection or an imprint, etc. Many other types of markings are conceivable. Depending on the type of marking, the marking detection device may include, for example, an inductive, capacitive or optical sensor.

The marking may be placed anywhere on the workpiece. In the simplest case, for example, it may be provided on a face of the workpiece radially inside the first gearing and aligned directly with the reference tooth structure. However, the marking may also be aligned with a different tooth structure of the first gearing than the reference tooth structure. The marking may even be provided at a location of the workpiece that is relatively far away from the reference tooth structure, e.g., on a shaft or in the region of the second tooth structure. It is sufficient that it is known how the position of the marking can be used to draw an unambiguous conclusion about the position of the reference tooth structure. A high degree of precision in determining the position is not necessary, since the reference tooth structure only needs to be identified on the basis of the marking, while its exact position is then determined in a separate measurement.

In advantageous embodiments, the marking detection device comprises first and second marking sensors, wherein the first and second marking sensors may be arranged e.g. one behind the other or side by side with respect to a circumferential direction of the workpiece. The detection of the marking of the workpiece may then advantageously comprise the forming of a difference of signals of the first and second marking sensors in order to detect the marking with greater certainty.

As an alternative or in addition to a marking sensor, the reference identification device may comprise a non-contact (i.e., contactlessly operating) first meshing sensor and a non-contact second meshing sensor. The identification of at least one reference tooth structure of the first gearing may then be carried out using a so-called “best fit” method. This may include the following steps:
determining rotational angular positions of tooth structures of the gearing with the first meshing sensor;
determining rotational angular positions of tooth structures of the second gearing with the second meshing sensor;
determining rotational angular distances of tooth structures of the first gearing to tooth structures of the second gearing from the determined rotational angular positions; and
identifying the at least one reference tooth structure of the first gearing on the basis of a comparison of the rotational angular distances with a specified nominal distance (distance setpoint).

As a reference measuring device for measuring the reference tooth structure, in particular, a tactile or optical sensor may be used. Such sensors enable the reference tooth structure to be measured with particularly high precision. If the reference measuring device includes a tactile sensor, it may comprise a sensor base and a probe tip. In some embodiments, the probe tip may be extended in relation to the sensor base in order to be brought into engagement with the first gearing along a preferably radial insertion direction without having to move the entire tactile sensor. This is particularly advantageous if the tactile sensor is arranged on a common sensor carrier with other sensors, especially with the reference identification device. In other embodiments, the entire tactile sensor can be moved or swiveled relative to the sensor carrier in order to bring it into engagement with the first gearing.

Measurement with a tactile sensor may be carried out in particular by changing the rotational angular position of the workpiece back and forth by a small amount while the probe tip is located next to a tooth flank of the reference tooth structure. The angular positions of the workpiece in which the left and right flank of the reference tooth structure is in contact with the probe tip are then determined, respectively, and, e.g., an average value is calculated from these angular positions. This can optionally be done at several locations in flank direction and/or in profile direction. For the measurement of the reference tooth structure, however, other tactile or optical methods can also be used, as they are generally known from the field of gear inspection.

In addition, the method may comprise checking the first gearing with a non-contact first meshing sensor and/or the second gearing with a non-contact second meshing sensor while the workpiece rotates around the workpiece axis. This is particularly useful if the reference tooth structure is identified by means of a marking. In particular, this allows a consistency check to be performed.

In particular, the first meshing sensor may be used to check the first gearing before measuring the reference tooth structure with the reference measuring device, e.g., to detect errors in the identification of the reference tooth structure or pre-machining errors of the first gearing. The inspection of the first gearing with the meshing sensor can be used in particular to check whether the expected type of tooth structure (e.g., a tooth gap) is actually present at the position determined by the reference identification device. If the expected type of tooth structure is not present at the determined position, there is an error and the process can be stopped. The first meshing sensor may also be used to determine the rotational angular position of the reference tooth structure more precisely than is possible with the marking alone. The measurement of the reference tooth structure by the reference measuring device can then be carried out very specifically and correspondingly at high speed.

The second meshing sensor can be used to check the second gearing to detect pre-machining errors of the second gearing. In particular, it is possible to detect workpieces on which the intended machining cannot be carried out or cannot lead to the desired result because the pre-machining errors are too large. In particular, it can be prevented that in extreme cases, when meshing the machining tool with the workpiece in the rotational angular position determined on the basis of the determined reference rotation angle, the machining tool is damaged because the pre-machining errors are too large.

In advantageous embodiments, the reference measuring device is attached to a sensor carrier. Further sensor devices may be attached to the sensor carrier, in particular at least part of the reference identification device such as the marking sensor and/or one or more meshing sensors. This results in a compact unit that can be moved as a whole relative to the workpiece.

The sensor carrier may be movable between a measuring position and a parking position, e.g. to enable collision-free loading and unloading of the workpiece or to protect the above-mentioned sensor devices from harmful influences by chips and coolant during workpiece machining. This movement of the sensor carrier may be achieved in particular by a swiveling movement around a swivel axis, which may, for example, run perpendicular or parallel to the workpiece axis, or by a translational movement along a linear direction, which may, for example, be radial or parallel to the workpiece axis.

In order to ensure the highest possible accuracy in determining the reference angular position even if the components involved expand or warp due to thermal influences, the method may include determining the position of the sensor carrier with respect to at least one spatial direction in the measuring position. In particular, the position of the sensor carrier relative to the workpiece may be determined in the measuring position with respect to one or more of the following spatial directions: a tangential direction, which runs tangentially to the workpiece; an axial direction, which runs parallel to the workpiece axis; and a radial direction, which runs radially to the workpiece axis. A corresponding position reference device may be provided for this purpose. A possible position reference device is described in more detail below. The determined reference angular position may then be corrected by means of the determined position of the sensor carrier in space.

The rotational angular positions of the workpiece may differ between the identification of the reference tooth structure and its measurement, since the reference identification device and the reference measurement device are not necessarily aligned with each other. The corresponding difference in rotation angle may be calibrated with the aid of a master workpiece, i.e., with a workpiece that corresponds exactly to the intended workpiece design. The relative rotational angular positions of the workpiece during the measurement of the reference tooth structure and the machining of the workpiece, as well as the relative rotational angular position of the tool may also be calibrated in this way. The angular positions of further sensors may also be calibrated with the master workpiece.

The positioning of the various sensor devices on the sensor carrier (reference identification device, reference measurement device, etc.) may be done with the help of a gauge. The gauge may correspond, for example, geometrically to a workpiece blank whose geometry is selected like the workpiece to be machined, but which does not have any pre-machined gearings, and in which there is a certain allowance of, for example, 0.1 mm in the direction of the sensor devices. The sensor devices may then be positioned by bringing them into contact with this gauge.

The proposed method is equally suitable for external and internal gearings. In particular, the following combinations are possible:
Both the first gearing and the second gearing are external gearings; in this case, the reference measuring device points inwards in the measuring position, i.e. in the direction of the workpiece axis, and if meshing sensors are present, they also point inwards in the measuring position.
Both the first gearing and the second gearing are internal gearings; in this case the reference measuring device points outwards in the measuring position, i.e. away from the workpiece axis, and if meshing sensors are present, they also point outwards in the measuring position.
The first gearing is an internal gearing and the second gearing is an external gearing; in this case the reference measuring device points outwards in the measuring position, and if meshing sensors are present, the first meshing sensor points outwards and the second meshing sensor points inwards in the measuring position.
The first gearing is an external gearing and the second gearing is an internal gearing; in this case, the reference measuring device points inwards in the measuring position, and if meshing sensors are present, the first meshing sensor points inwards and the second meshing sensor points outwards in the measuring position.

In a second aspect, the present invention provides a positioning device for determining a reference rotational angular position of a workpiece. Again, the workpiece has a first and second gearing. The positioning device comprises:
a reference identification device configured to identify without contact at least one reference tooth structure of the first gearing; and
a reference measuring device configured to measure the reference tooth structure of the first gearing identified by the reference identification device in order to determine the reference rotational angular position of the workpiece.

The positioning device may be specifically designed to be used in the methods described above.

As already mentioned, the reference identification device may include a marking detection device that is configured to detect a marking on the workpiece without contact. The marking detection device may comprise first and second marking sensors, wherein the first and second marking sensors may be arranged behind each other or side by side with respect to a circumferential direction of the workpiece.

As already mentioned, the reference identification device may comprise in the alternative or in addition:
a non-contact first meshing sensor for determining rotational angular positions of tooth structures of the first gearing; and
a non-contact second meshing sensor for determining rotation angular positions of tooth structures of the second gearing.

As mentioned above, the reference measuring device may comprise a tactile or optical sensor. The tactile sensor may comprise a probe tip that can be extended relative to a sensor base to be brought into engagement with the first gearing along a preferably radial insertion direction. Alternatively or additionally, the tactile sensor may be linearly movable or pivotable with respect to a sensor base to bring it into engagement with the first gearing.

If the positioning, device includes a first and/or second meshing sensor, it is advantageous if the first and/or second meshing sensor is offset from the reference measuring device along a circumferential direction of the workpiece. This avoids having to move the positioning device between the use of the meshing sensors and the use of the reference measuring device. In particular, it is advantageous if the first and/or second meshing sensor defines a radial measuring direction which is at an angle to the insertion direction of the probe tip, preferably with both the radial insertion direction of the probe tip and the radial measuring direction being parallel to a plane normal to the workpiece axis.

The marking detection device, if present, may define a detection direction that is different from the insertion direction of the probe tip, e.g. perpendicular to it. However, other configurations are also possible, the exact configuration depending strongly on the position of the marking on the workpiece.

As already mentioned, the positioning device may comprise a sensor carrier on which the reference measuring device is mounted. Preferably at least part of the reference identification device is also attached to the sensor carrier. The sensor carrier may be movably connected to a base element in order to move the sensor carrier between a parking position and a measuring position, in particular by swiveling it about a swivel axis extending, for example, perpendicularly or parallel to the workpiece axis or by linearly moving it along a linear direction extending, for example, radially or parallel to the workpiece axis.

The positioning, device may be part of a machine tool for machining the second gearing. The machine tool may comprise a workpiece carrier and at least one workpiece spindle mounted thereon, the workpiece spindle being configured to receive the workpiece for rotation about the workpiece axis. The machine tool may also comprise a machine bed. The workpiece carrier may be part of the machine bed or rigidly connected to it, or it may be movable relative to the machine bed, in particular, to swivel around a workpiece carrier axis.

If the workpiece carrier is movable relative to the machine bed and the sensor carrier is movably connected to a base element, it may be advantageous if the base element is located on the machine bed, i.e. if the positioning device is not moved with the workpiece carrier.

If a position reference device is available, it may comprise at least one position reference target and at least one position reference sensor. In this case it is advantageous if either the at least one position reference target is connected with the workpiece carrier and the at least one position reference sensor with the sensor carrier, or the at least one position reference target is connected with the sensor carrier and the at least one position reference sensor with the workpiece carrier.

It is also conceivable to arrange the positioning device, especially the sensor carrier, on the workpiece carrier so that it moves along with the workpiece carrier. This has the advantage that the identification and measurement of the reference tooth structure can be carried out not only while the workpiece carrier is stationary, but also while the workpiece carrier is moving. Thus, non-productive times can be minimized. If the workpiece carrier can be swiveled around a workpiece carrier axis in relation to the machine bed, it may be advantageous if the sensor carrier is positioned on the workpiece carrier in a location radially between the workpiece carrier axis and the workpiece axis.

The machine tool may also comprise a tool spindle configured to receive a machining tool for rotation about a tool axis. It may also comprise a control device configured to carry out the operations described above. In particular, the control device may be configured to move the sensor carrier between the parking position and the measuring position, in particular to swivel or linearly move it. The control device may also be configured to determine the position of the sensor carrier relative to the workpiece in the measuring position by means of the position reference device with respect to at least one spatial direction, in particular the above-mentioned tangential direction, axial direction and/or radial direction. The control device may also be configured to move the probe tip of the tactile sensor relative to the sensor carrier along the insertion direction in order to insert the probe tip into the first gear. In addition, the control device may be configured to measure the first gearing with the non-contact first meshing sensor before the tactile sensor is engaged with the first gear, and/or to measure the second gear with the non-contact second meshing sensor to detect pre-machining errors of the second gear.

### BRIEF DESCRIPTION OF THE DRAWINGS

Preferred embodiments of the invention are described in the following with reference to the drawings, which serve only for explanation and are not to be interpreted as limiting. In the drawings:

FIG. 1 shows a schematic perspective view of a finishing machine with a positioning device according to a first embodiment in a measuring position;

FIG. 2 shows a perspective view of the positioning device according to the first embodiment in a parking position;

FIG. 3 shows a perspective view of the positioning device according to the first embodiment in the measuring position;

FIG. 4 shows an enlarged view of detail IV in FIG. 3;

FIG. 5 shows a plan view of the positioning device according to the first embodiment in the measuring position, with retracted probe tip;

FIG. 6 shows a plan view of the positioning device according to the first embodiment in the measuring position, with the probe tip extended;

FIG. 7 shows a flow chart for an exemplary method of machining a workpiece;

FIG. 8 shows a plan view of a positioning device according to a second embodiment in a measuring position, a parking position being indicated by broken lines;

FIG. 9 shows a side view of a positioning device according to a third embodiment in a measuring position;

FIG. 10 shows a side view of a positioning device according to a fourth embodiment in a measuring position;

FIG. 11 shows a plan view of the positioning device of the fourth embodiment in the measuring position;

FIG. 12 shows a plan view of the positioning device of the fourth embodiment in a parking position;

FIG. 13 shows a schematic perspective view of a finishing machine with a positioning device according to a fifth embodiment;

FIG. 14 shows an enlarged view of the positioning device of the fifth embodiment with retracted probe tip;

FIG. 15 shows a view of the fifth embodiment with extended probe tip;

FIG. 16 shows a perspective view of a positioning device according to a sixth embodiment;

FIG. 17 shows an enlarged view of detail XVII in FIG. 15;

FIG. 18 shows a perspective view of a positioning device according to a seventh embodiment;

FIG. 19 shows an enlarged view of detail XIX in FIG. 17;

FIG. 20 shows a diagram which illustrates the time course of sensor signals of the marking detection device of the positioning device according to the sixth embodiment;

FIG. 21 shows a diagram illustrating the time course of the difference of the sensor signals from FIG. 19 as an example;

FIG. 22 shows a schematic view of a double gearing to illustrate a “best fit” method;

FIG. 23 shows a schematic perspective view of a positioning device according to an eighth embodiment in a parking position;

FIG. 24 shows an enlarged view of detail A in FIG. 23;

FIG. 25 shows a schematic side view of the positioning device of FIG. 23 in a measuring position;

FIG. 26 shows a schematic plan view of the positioning device of the eighth embodiment in the measuring position;

FIG. 27 shows a schematic perspective view of the positioning device according to the eighth embodiment in the parking position, with an additional position reference device;

FIG. 28 shows a schematic perspective view of a positioning device according to a ninth embodiment in a parking position;

FIG. 29 shows a schematic perspective view of the positioning device according to the ninth embodiment in a measuring position;

FIG. 30 shows a schematic side view of the positioning device according to the ninth embodiment in the measuring position, with a cut-out to show the reference measuring device in a swiveled-out position;

FIG. 31 shows a schematic side view of the positioning device according to the ninth embodiment in the measuring position, with a cut-out to show the reference measuring device in a swung-in position;

FIG. 32 shows a schematic perspective view of a positioning device according to a tenth embodiment in a parking position;

FIG. 33 shows a schematic perspective view of the positioning device according to the tenth embodiment in a measuring position;

FIG. 34 shows a schematic perspective view of a gear skiving machine with a positioning device according to an eleventh embodiment in a measuring position;

FIG. 35 shows an enlarged detail view in area XXXV of FIG. 34; and

FIG. 36 shows a schematic perspective view of a positioning device according to a twelfth embodiment in a parking position.

### DESCRIPTION OF PREFERRED EMBODIMENTS

Structure of an Exemplary Finishing Machine

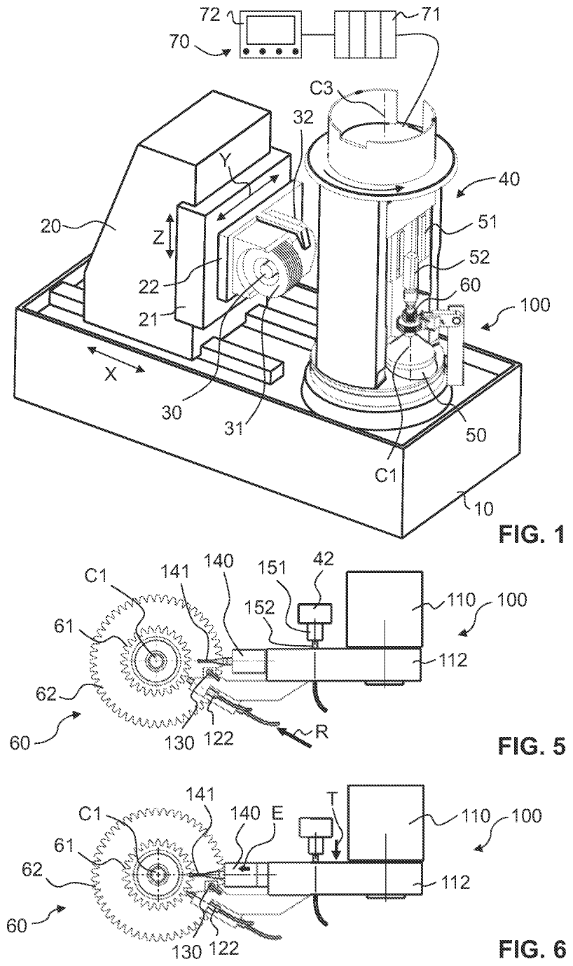

FIG. 1 shows a finishing machine for hard finishing of gears by generating grinding. The machine comprises a machine bed 10 on which a tool carrier 20 is arranged so as to be movable along a horizontal infeed direction X. A Z-slide 21 is arranged on the tool carrier 20 and can be moved along a vertical direction Z. A Y-slide 22 is arranged on the Z-slide 21, which, on the one hand, can be swiveled relative to the Z-slide 21 about a horizontal swivel axis not shown in FIG. 1, which runs parallel to the X-axis, and, on the other hand, can be moved along a shift direction Y, which runs perpendicular to the X-axis and at an adjustable angle to the Z-axis. The Y-slide 22 carries a tool spindle 30, on which a finishing tool in the form of a grinding worm 31 is clamped. The tool spindle 30 comprises a tool spindle drive 32 to drive the grinding worm 31 to rotate about a tool spindle axis.

A swiveling workpiece carrier in the form of a turret 40 is arranged on the machine bed 10. The turret 40 can be swiveled around a vertical swivel axis C3 between a plurality of rotation positions. It carries two workpiece spindles 50, on each of which a workpiece 60 can be clamped, A counter column 51 carries a vertically movable tailstock 52 for each workpiece spindle. Each of the workpiece spindles 50 can be driven to rotate about a workpiece axis. In FIG. 1, the workpiece axis of the visible workpiece spindle 50 is marked C1. The two workpiece spindles are located on the turret 40 in diametrically opposite positions (i.e., offset by 180° with respect to the swivel axis C3). In this way, one of the two workpiece spindles can be loaded and unloaded, while on the other workpiece spindle a workpiece is machined by the grinding worm 31. This largely avoids unwanted non-productive times. Such a machine concept is known from WO 00/035621 A1, for example.

Workpiece 60 has two external gearings. A positioning device 100, which is described in more detail below, is used to align workpiece 60 with respect to its angular position about the workpiece axis C1 in such a way that the larger of the two gearings can be brought into collision-free engagement with the grinding worm 31 and this gearing can then be machined in such a way that, after machining, it assumes a previously determined angular position relative to the other gearing with high precision.

The machine comprises a symbolically displayed machine controller 70, which comprises several control modules 71 and a control panel 72. Each of the control modules 71 controls a machine axis and/or receives signals from sensors. In this example, at least one of the control modules 71 is configured to interact with the sensors of the positioning device 100 described in more detail below.

Workpiece with Two External Gearings: Positioning Device with Horizontal Swivel Axis

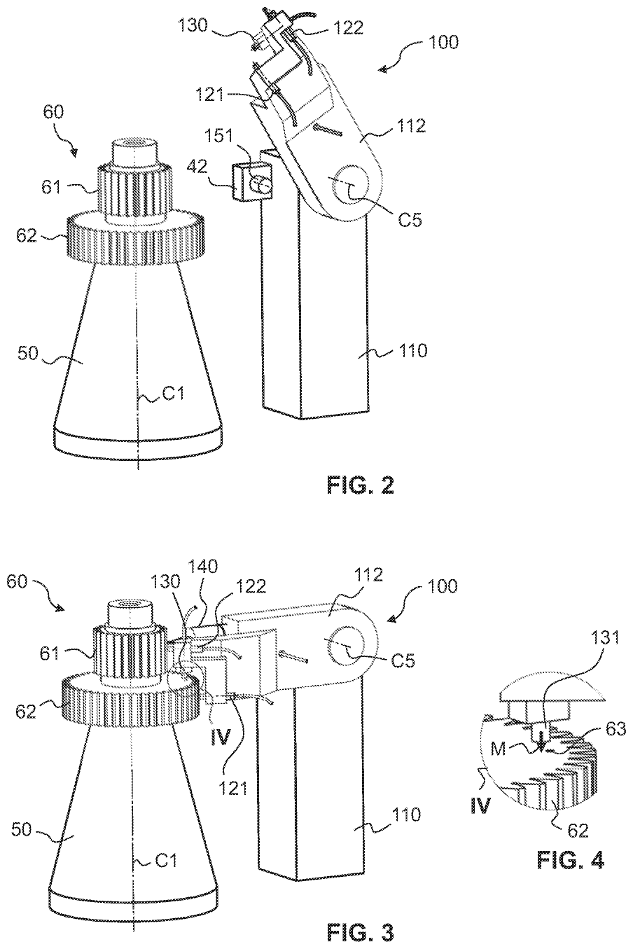

FIGS. 2 to 6 show a positioning device 100 according to a first embodiment together with the workpiece 60 clamped on the workpiece spindle 50.

As shown in FIGS. 2 and 3 in particular, the workpiece 60, which is shown here as an example, has a shaft on which two differently sized spur gears are formed at axially different positions. The spur gears are formed in one piece with the shaft. The smaller of the two spur gears has a first gearing 61. This gearing is also referred to as reference gearing in the following. The larger of the two spur gears has a second gearing 62. This gearing is to be machined with the finishing machine. In this example, the gearings 61, 62 differ not only in their tip circle diameter but also in the number of teeth. This example shows spur gears, but the gears may also be helical gears. In this example, both gearings extend completely around the workpiece axis; however, one or both gearings may also be formed only in segments.

Workpiece 60 also has a marking. In this example, the marking is formed by a hole 63, which is formed in the larger of the two spur gears in an area radially inside the second gearing 62 and runs parallel to the workpiece axis C1 Other types of markings are also conceivable, e.g. an engraving, a chamfer, a projection, a color marking, etc. The marking can also be formed at a different location on the workpiece. For example, a hole can run diametrically through the shaft, or the shalt can have a chamfer, Many other variations are conceivable.

The positioning device 100 comprises a base element 110, which is connected to the machine bed 10 in the finishing machine shown in FIG. 1. A sensor carrier 112 in the form of a swivel arm is attached to the base element 110. The sensor carrier 112 can be pivoted relative to the base element 110 and thus relative to the machine bed 10 about a horizontal axis C5 between a parking position (FIG. 2) and a measuring position (FIGS. 3 to 6).

The sensor carrier 112 carries two meshing sensors 121, 122, the first meshing sensor 121 being directed along a radial measuring direction R toward the reference gearing 61 and the second meshing sensor 122 being aligned along the radial measuring direction R toward the gearing 62 to be machined. The meshing sensors 121, 122 are, e.g., inductive or capacitive distance sensors, which detect by a distance measurement whether they are aligned to a tooth tip or a tooth gap. The meshing sensors 121, 122 thus enable a quick inspection of the gearings 61, 62 and a determination of the positions of all tooth gaps while the workpiece 60 rotates.

The sensor carrier 112 further carries a marking detection device 130, which in the present example consists of a single marking sensor 131 (see FIG. 4). In the present example, the marking sensor 131 is configured as an inductive or capacitive distance sensor, similar to the meshing sensors 121, 122. It is aligned with the face of the workpiece 60 in which the hole 63 is formed. When the workpiece 60 rotates, the marking sensor 131 registers a distance change along a marking detection direction M when the hole passes it. On this basis, the machine control 70 can determine the angle of rotation of workpiece 60 at which hole 63 is aligned with marking sensor 131. Depending on the type and location of the marking, other marking sensors can also be used, e.g. an optical sensor. The marking sensor makes it possible to uniquely identify a reference tooth structure, in particular a reference tooth or a reference tooth gap, in reference gearing 61 on the basis of the position of the marking.

The sensor carrier 112 further carries a reference measuring device 140 to measure the reference tooth structure and thus determine a reference angular position of the workpiece 60 with high precision. The reference measuring device 140 is directed radially toward the workpiece axis C1 In the present example, the reference measuring device 140 is configured as a tactile sensor. The tactile sensor has a base that is connected to the sensor carrier 112 and a probe tip 141 that can be extended and retracted relative to the base between a retracted position (see FIG. 5) and an extended position (see FIG. 6). This allows the probe tip 141 to be retracted along an insertion direction E into the reference gearing 61 without having to move the sensor carrier 112. The insertion direction E here corresponds to a radial direction with respect to the workpiece axis C1 However, the reference measuring device 140 can also be designed in another way, e.g., as an optical sensor.

Finally, the sensor carrier 112 carries a tangential position sensor 152, which is aligned with a position reference target 151 arranged on the turret 40 via a reference carrier 42. The tangential position sensor 152 is configured as a distance sensor, similar to the meshing sensors 121, 122 and the marking sensor 131. In the measuring position, it measures a distance of the tangential position sensor 152 to the position reference target 151 along a tangential direction T with respect to the workpiece 60. Based on the measured distance, measuring errors of the reference angular position due to length changes and distortions caused by thermal effects, which result in the reference measuring device 140 no longer being directed exactly radially toward the workpiece axis C1, can be corrected. This can improve the accuracy of the determined reference angular position. Alternatively, the tangential position sensor 152 and the position reference target 151 may be interchanged.

Machining of a Workpiece

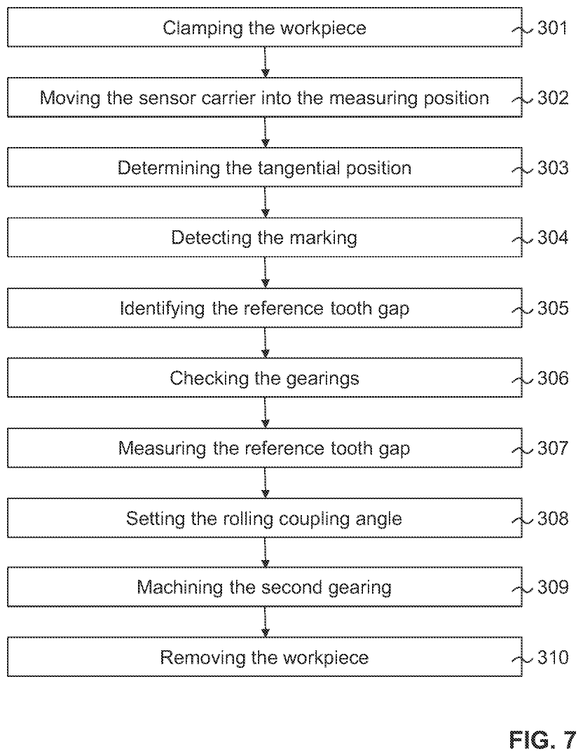

FIG. 7 illustrates an exemplary flow chart for machining the workpiece 60 with the finishing machine shown in FIG. 1.

In step 301, the workpiece 60 is clamped on the workpiece spindle 50. In step 302, the sensor carrier 112 is moved from the parking position of FIG. 2 to the measuring position of FIGS. 3 to 6. In step 303, the tangential position of the sensor carrier 112 is determined using the tangential position sensor 152, and a correction value for the reference rotational angle position to be determined is derived from this. In step 304, the position of the hole 63 is determined using the marking detection device 130. In step 305, the reference tooth structure is identified on this basis.

In step 306, the two gearings 61, 62 are checked with the aid of the meshing sensors 121, 122. On the one hand, a consistency check is performed to determine whether the desired type of tooth structure is actually present at the position where the reference tooth structure should be located according to the marking. Otherwise, the process is stopped and an error message is output. On the other hand, a check is performed to see how the second gearing is aligned relative to the first gearing. For this purpose, on the one hand, a check is made to see whether a tooth structure of the second gearing is aligned with the reference tooth structure within acceptable tolerances; on the other hand, a check is made for pre-machining errors. If this check shows that the second gearing can be successfully machined, the process is continued. Otherwise, the operation is stopped and the workpiece is discarded as an NIO (“not in order”) part.

The reference tooth structure is now measured in step 307. To do this, workpiece 60 is brought into a rotational angular position in which the probe tip 131 can be moved into the reference tooth structure, using workpiece spindle 50. The reference tooth structure is now measured using a procedure that is known from gear inspection by checking in which angular positions of the workpiece the probe tip 131 touches the right and left flanks of the reference tooth structure. From this the reference angular position of the workpiece is determined.

In step 308, the rolling coupling angle between workpiece 60 and grinding worm 31 is determined on this basis. The sensor carrier 112 is moved back into the parking position, and the turret 40 is swiveled 180° around the C3 axis to bring the workpiece spindle 50 into the machining position. Now, in step 309, the to-be-machined gearing 62 of workpiece 60 is machined with the grinding worm 31. The turret 40 is now swiveled again by 180°, and the machined workpiece 60 is removed in step 310. The machined gearing 62 is now exactly aligned with reference to the reference gearing 61 in the desired manner.

Of course, various modifications to this exemplary flow chart are conceivable.

Workpiece with Two External Gearings: Positioning Device with Vertical Swivel Axis

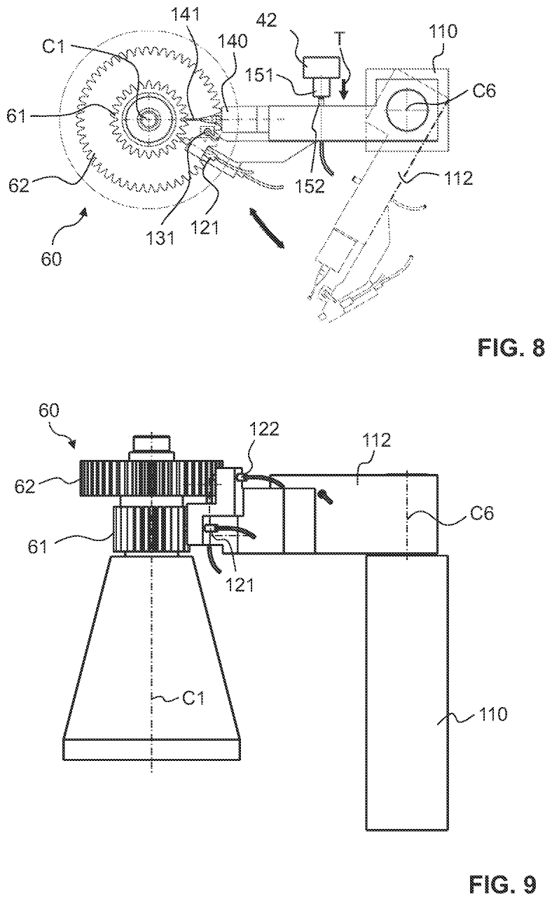

FIG. 8 shows a positioning device according to a second embodiment. Components with the same or similar function are marked with the same reference signs as in FIGS. 1 to 6. This positioning device differs from the positioning device in FIGS. 1 to 6 in that the sensor carrier 112 can be swiveled not about a horizontal axis but about a vertical axis C6 relative to the base element 110. This is particularly advantageous if the workpiece 60 is to be clamped in such a way that the larger of the two gearings 61, 62 is located above the smaller gearing. It is then no longer possible to swivel the sensor carrier 112 collision-free around a horizontal axis.

This is illustrated in FIG. 9, which shows a positioning device according to a third embodiment. Components with the same or similar function are again marked with the same reference signs as in FIGS. 1 to 6. Workpiece 60 is now upside down relative to the embodiment shown in FIG. 8. The arrangement of the various sensor devices on the sensor carrier 112 is adapted accordingly. It can be seen that the sensor carrier 112 can be swiveled in and out around the vertical axis C6 without collision.

Workpiece with Two External Gearings: Positioning Device with Linear Displacement Axis

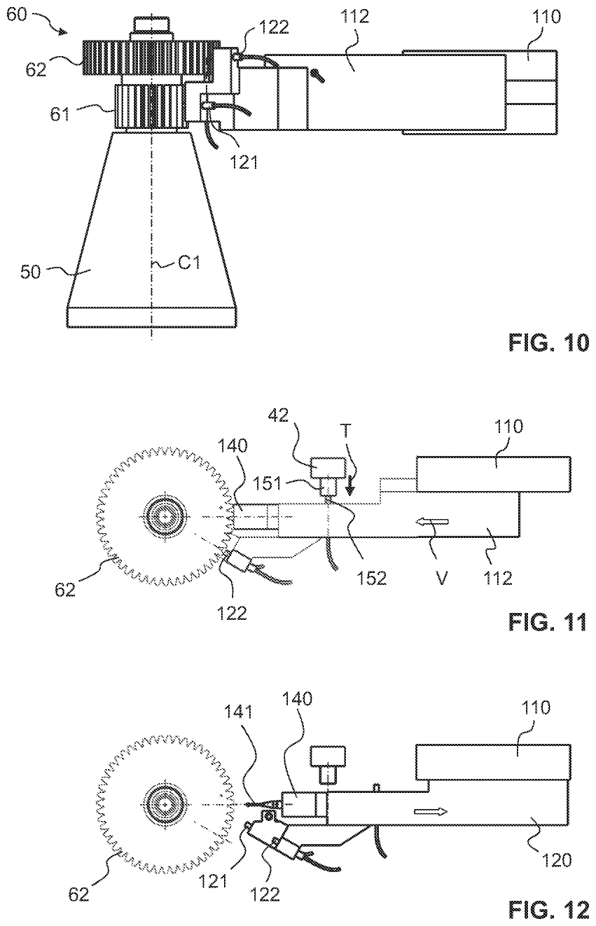

Alternatively, it is also possible to move the sensor carrier. This is illustrated in FIGS. 10 to 12, which show a positioning device according to a fourth embodiment. The sensor carrier 112 can be moved linearly between a measuring position (FIG. 11) and a parking position (FIG. 12). The linear displacement direction V coincides here with the insertion direction E of the probe tip 141. However, the retraction and extension movement of the probe tip 141 is still independent of the displacement of the sensor carrier 112.

Workpiece with Two External Bearings: Positioning Device on the Turret

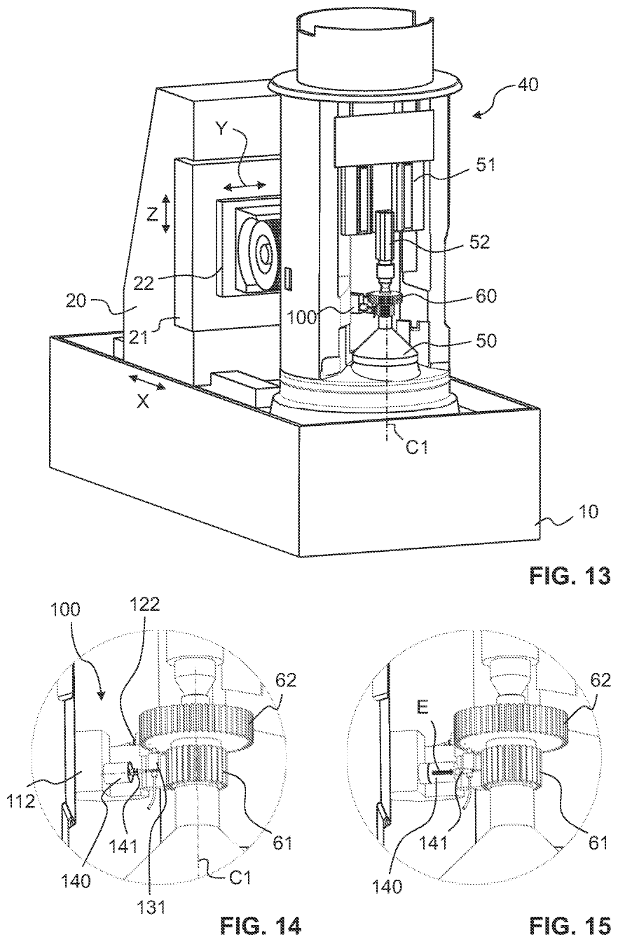

It is also possible to attach the positioning device to turret 40. This allows non-productive times to be further minimized. This is illustrated in FIGS. 13 to 15, which show a finishing machine with a positioning device according to a fifth embodiment. Components with the same or similar function are again marked with the same reference signs as in FIGS. 1 to 6. Here, the sensor carrier 112 is attached to the turret 40 and can be moved relative to it along the vertical direction. The probe tip 141 can also be inserted here radially to the workpiece axis C1, i.e., horizontally, into the reference gearing.

Marking Detection by Difference Formation

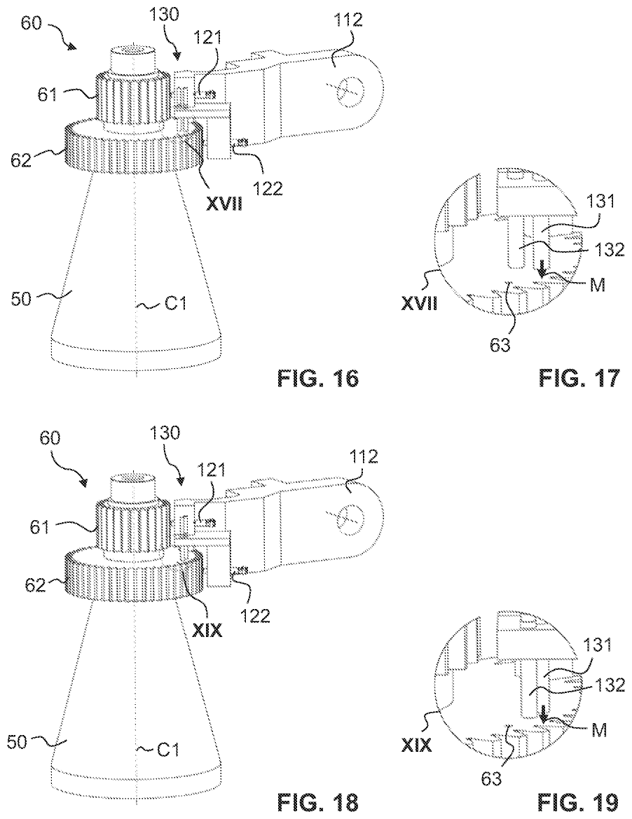

FIGS. 16 and 17 illustrate a positioning device according to a sixth embodiment, whose marking detection device 130 comprises two marking sensors 131, 132. The marking sensors are again inductive or capacitive distance sensors, which determine the distance from the front side of the respective sensor to the opposite surface of the workpiece. They each output a signal indicating the measured distance. The two marking sensors 131, 132 are arranged side by side with respect to the circumferential direction of the workpiece, i.e. one behind the other with respect to the radial direction. When the workpiece rotates, the hole 63 passes the outer marking sensor 131, while the inner marking sensor 132 remains unaffected by the hole.

Alternatively, the marking sensors 131, 132 can also be arranged one behind the other with respect to the circumferential direction of the workpiece, i.e. on the same radius with respect to the workpiece axis. A corresponding seventh embodiment is illustrated in FIGS. 18 and 19. In this case, the two marking sensors detect the hole one after the other.

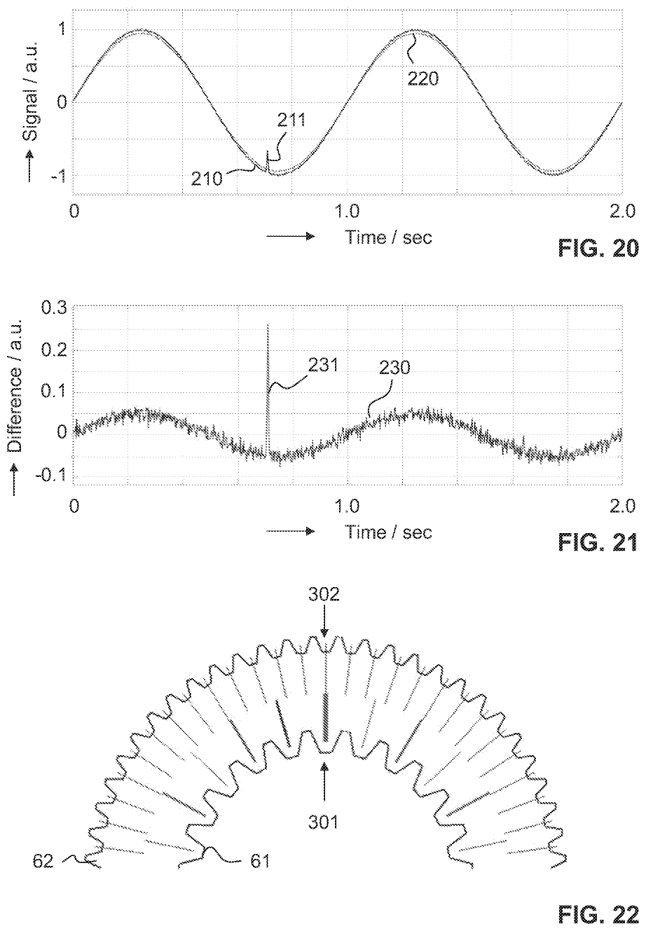

The resulting output signals of the sixth embodiment are illustrated as an example in FIG. 20. In this example, the workpiece is clamped with a relatively large axial run-out error. Due to the axial run-out error, each of the two marking sensors registers a sinusoidal signal 210, 220, whose frequency corresponds to the rotation frequency of the workpiece. The signal 210 of the first marking sensor 131 also has a peak 211, which is caused by the passing hole 63. The peak indicates the rotational angular position in which hole 63 is opposite the marking sensor 131. Since hole 63 has a relatively small diameter, which is smaller than the active area of sensor 131, this signal is relatively small compared to the amplitude of the sinusoidal component. It is therefore not always easy to detect the peak unambiguously with conventional signal processing methods.

To facilitate a unique identification of the peak, the difference of the signals 210, 220 of the two marking sensors 131, 132 may be formed. The difference signal is shown in FIG. 21. The difference signal 230 now has a peak 231 which clearly exceeds the superimposed residual sinusoidal signal and the noise. The peak can now be detected e.g. by simple thresholding.

In the seventh embodiment, the difference formation leads to two peaks with opposite signs, which follow each other in time. These two peaks can also be reliably detected.

Identification of a Reference Tooth Structure Using a “Best-Fit” Method

Instead of using a marking, the reference tooth structure may be identified using a “best fit” method. This is illustrated in FIG. 22.

First, the rotational angular positions of tooth structures of the first gearing 61 are determined with a first meshing sensor and the rotational angular positions of tooth structures of the second gearing 62 are determined with a second meshing sensor. Then, the rotational angular distances between tooth structures of the first gearing 61 and tooth structures of the second gearing 62 are determined. These rotational angular distances are compared with a specified distance setpoint. The system searches for the tooth structure of the first gearing 61 whose rotational angular distance to any tooth structure of the second gearing 62 matches the specified distance setpoint with best accuracy (“best fit”). For example, the system searches for the tooth structure of the first gearing 61 that has the minimum rotational angular distance to a tooth structure of the second gearing 62, i.e. is aligned as precisely as possible with a tooth structure of the second gearing 62. In FIG. 22, this is tooth gap 301, which is almost perfectly aligned with tooth gap 302 of second gearing 62, and the rotational angular distance from all other tooth gaps of first gearing 61 to the next tooth gap of second gearing 62 is greater than for tooth gap pair 301, 302. Tooth gap 301 is thus identified as the reference tooth gap.

If the fraction of the number of teeth of the two tooth structures can be reduced, there are several tooth structures of the first gearing which, under ideal conditions, have the same rotational angular distance to a tooth structure of the second gearing. In other words, for example, if the first gearing has a number of teeth of kN₁ and the second gearing has a number of teeth of kN₂ has, where k, N₁ and N₂ are natural numbers greater than 1, and where N₁ and N₂ have no common prime factor except 1, there are theoretically k rotational angles of the workpiece where the tooth structures of the first and second gearings have the same rotational angular distance. In this case, when determining the “Best Fit”, the deviation of the rotational angular distance from the distance setpoint can be averaged over k tooth structures at rotational angular distances of 2π/k.

Workpiece with Two Internal Clearings: Positioning Device with Horizontal Swivel Axis

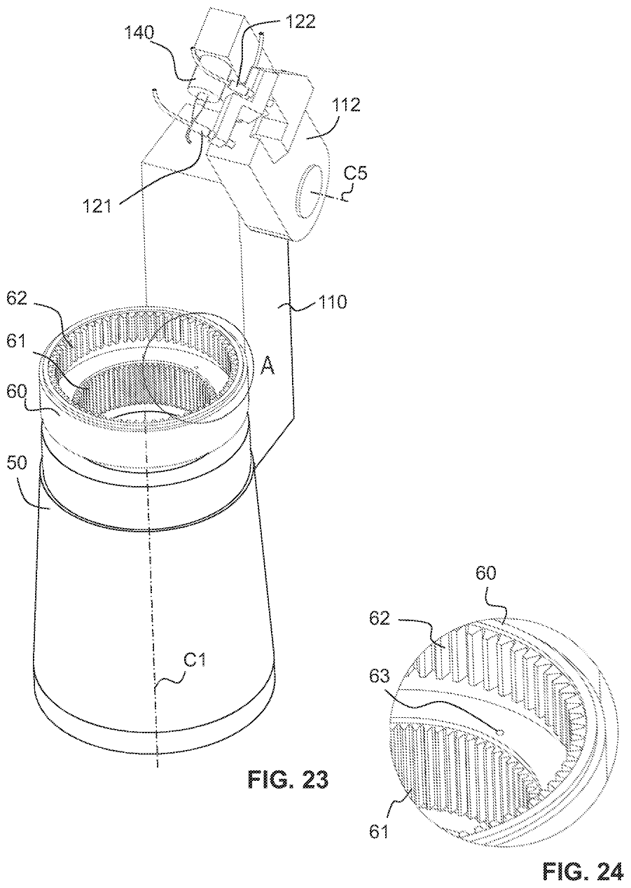

FIGS. 23 to 27 show a positioning device according to an eighth embodiment. Components with the same or similar function are again marked with the same reference signs as in FIGS. 1 to 6. The positioning device of the eighth embodiment is configured to determine a reference rotational angular position of a double-gearing workpiece 60 whose reference gearing 61 and gearing 62 to be machined are both configured as internal gearings.

Workpiece 60 again bears a marking 63 in the form of a hole (see FIG. 24). In this example, this hole is formed radially outside the reference gearing 61 and radially inside the gearing 62 to be machined and runs parallel to the workpiece axis C1.

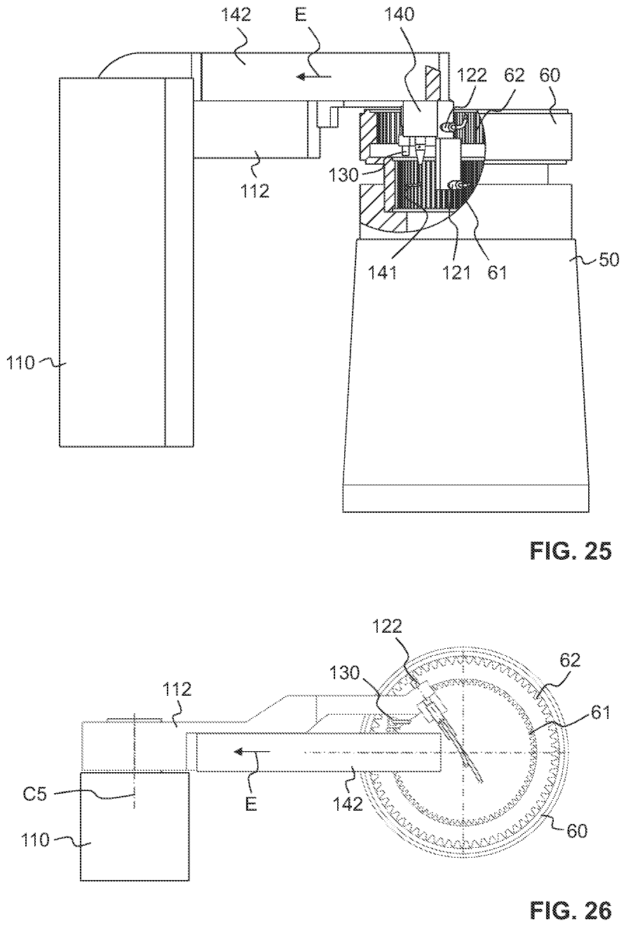

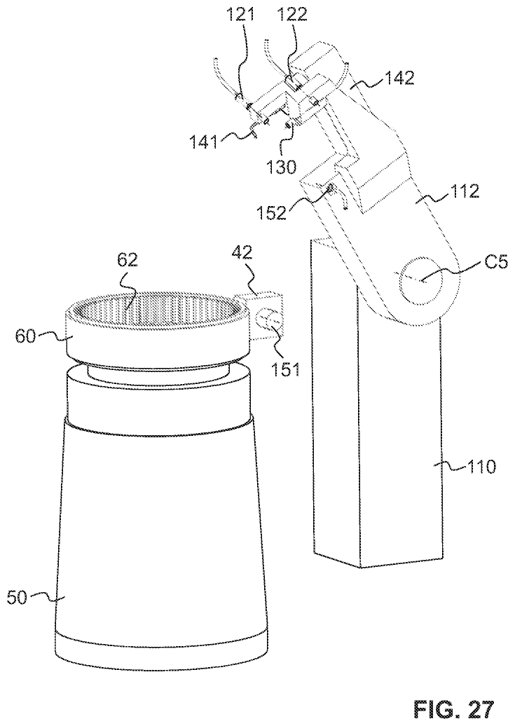

The positioning device of the eighth embodiment is basically similar to the positioning device of the first embodiment. It again comprises a base element 110 which is connected to a machine bed or workpiece carrier of a finishing machine. A sensor carrier 112 in the form of a swivel arm is attached to this base element 110. The sensor carrier 112 can again be swiveled relative to the base element 110 about a horizontal swivel axis C5 between a parking position (FIGS. 22, 27) and a measuring position (FIGS. 25, 26).

The sensor carrier 112 again carries two meshing sensors 121, 122, which are directed radially outwardly toward the inwardly oriented gearings 61, 62.

The sensor carrier 112 further carries a marking detection device 130, which here, as in the first version, comprises only a single marking sensor (see FIGS. 25 to 27).

Furthermore, the sensor carrier 112 carries a reference measuring device 140, which here again is configured as a tactile sensor with a probe tip 141. In contrast to the straight probe lip of the first embodiment, the probe tip 141 here is angled. In the direction of its free end it has a probe section which is oriented horizontally in the measuring position and is intended to be inserted radially into tooth gaps of the reference gearing 61, It also has a connecting section which is oriented vertically in the measuring position and connects the probe tip to a base of the reference measuring device 140. The connecting section and the probe section are connected by a curved section. In order to insert the probe tip 141 with its probe section into the tooth spaces of the reference gearing, the base of the reference measuring device is arranged on a linear slide 142. The linear slide 142 can be moved linearly on the sensor carrier 112 along an insertion direction E. The insertion direction is radial in the measuring position.

FIG. 27 also shows an optional position reference device. As with the embodiments discussed above, a tangential position sensor 152 on the sensor carrier 112 interacts here with a position reference target 151 on a reference carrier 42 to determine the position of the sensor carrier 112 with respect to a tangential direction tangential to the workpiece 60. Again, the roles of the tangential position sensor 152 and the position reference target 151 can also be interchanged, i.e. the tangential position sensor can be located on the reference carrier and the position reference target can be located on the sensor carrier.

The identification of a reference tooth structure of the reference gearing 61 and the determination of a reference rotational angular position of the workpiece 60 by measuring the reference tooth structure with the reference measuring device are carried out in a similar way to the first embodiment. The gearing 62 to be machined can then be finished with a finishing process suitable for machining internal gears, e.g. by gear skiving. For this purpose, the rolling coupling angle can again be set on the basis of the determined reference rotational angular position.

In FIGS. 23 to 27, the inside diameter of the reference gearing 61 is smaller than the inside diameter of the gearing 62 to be machined, so that the sensor carrier 112 can be brought into the measuring position without any problems and without collision by a simple swivel movement.

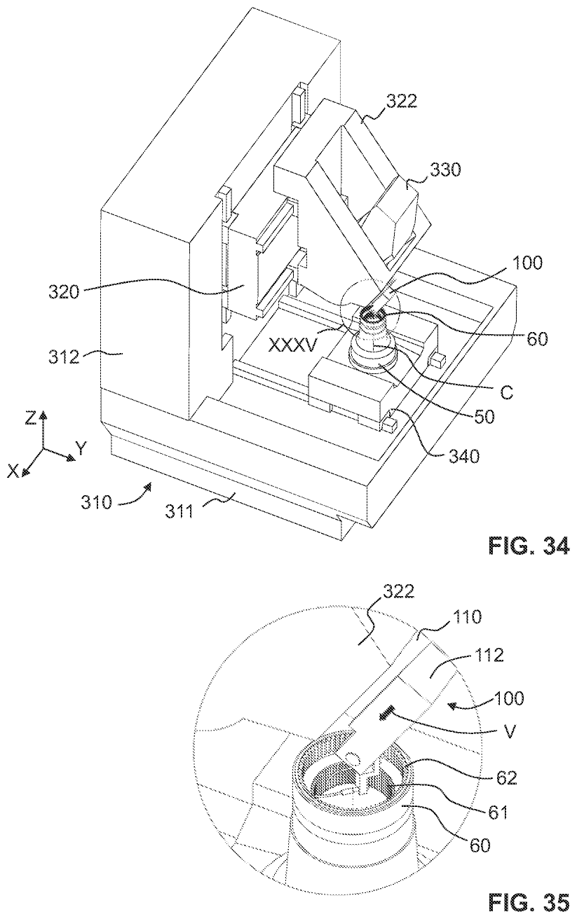

On the other hand, if the reference gearing 61 should have a larger inside diameter than the gearing 62 to be machined, the following considerations should be taken into account: For reasons of accessibility for the machining tool, the gearing 62 to be machined must usually still be located at the top. This means that it is no longer possible to bring the sensor carrier 112 into the measuring position without collision by a simple swivel movement around a horizontal axis alone. In this case there are several options. A first option is to provide an additional axis for the positioning device, e.g. an additional linear displacement axis. For example, the entire sensor carrier 112 could be mounted on a linear slide, which is radially displaceable with respect to the workpiece axis on a holder, whereby this holder in turn is attached to the stationary base element 110 so that it can be swiveled about axis C5, or the base element 110 itself could be linearly displaceable with respect to the machine bed. A second option is to attach the sensor carrier 112 to a machine element which is movable anyway by already existing machine axes, e.g. to the tool carrier. This will be explained in more detail below with reference to FIGS. 34 and 35. Of course, other options are also conceivable.

Workpiece with Two Internal Gearings: Positioning Device with Linear Displacement Axis

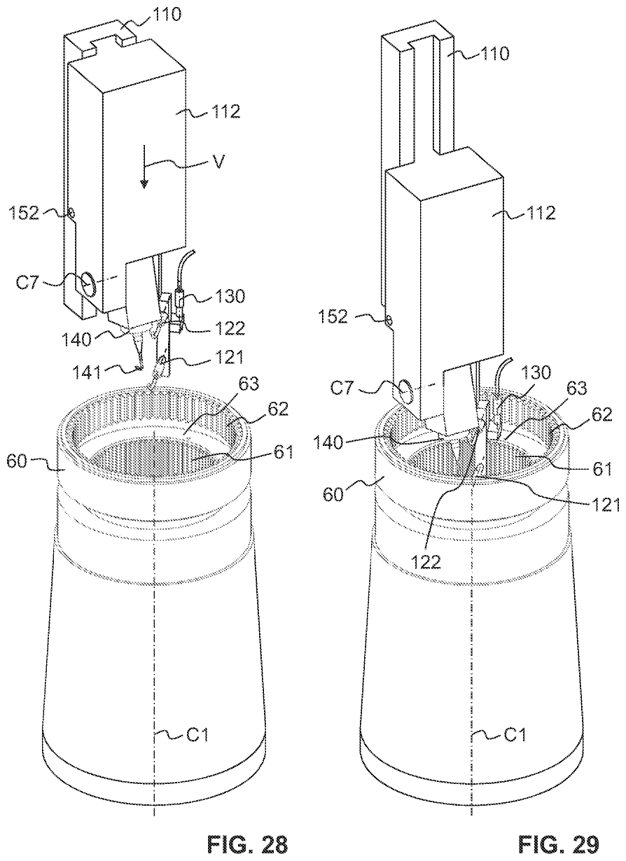

FIGS. 28 to 31 show a positioning device according to a ninth embodiment. Components with the same or similar function are again marked with the same reference signs as in FIGS. 1 to 6. Like the positioning device of the eighth embodiment, the positioning device of the ninth embodiment is configured to determine a reference rotational angular position of a double-gearing workpiece 60, whose reference gearing 61 and gearing 62 to be machined are both configured as internal gearings.

In contrast to the eighth embodiment, the sensor carrier 112 can be moved linearly along a displacement direction V relative to the base element 110 to move the sensor carrier 112 from the parking position (FIG. 28) to the measuring position (FIG. 29). Two meshing sensors 121, 122 and a marking detection device 130 are mounted on the sensor carrier 112. A tangential position sensor 152 is also mounted on or in the sensor carrier 112, which interacts with a position reference target not shown.

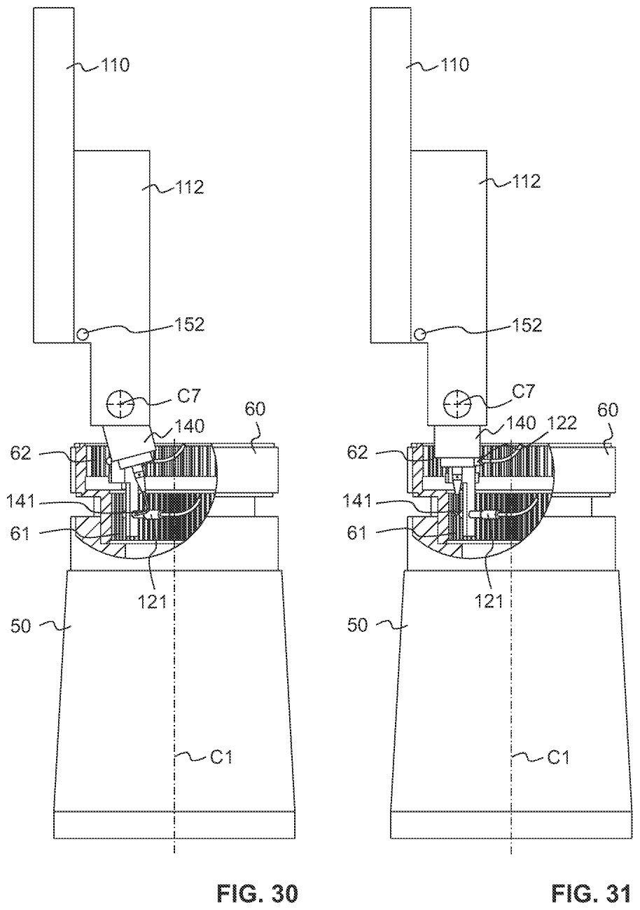

Again, the sensor carrier 112 also carries a reference measuring device 140 in the form of a tactile sensor with a curved probe tip 141. In order to bring the probe tip 141 into engagement with the reference gearing 61, the base of the reference measuring device 140 is pivotally connected to the sensor carrier 112. The corresponding swivel axis C7 runs horizontally here. The reference measuring device 140 can thus be swiveled between a swiveled out position (FIG. 30), in which the probe tip 141 is out of engagement with the reference gearing 61, and a swiveled in position (FIG. 31), in which the probe tip 141 is in engagement with the reference gearing 61. Instead of a horizontally extending swivel axis C7, a vertical or inclined axis is also conceivable.

This embodiment can also be modified so that the sensor carrier 112 can be brought into the measuring position without collision even if the upper gearing 62 to be machined has a smaller inner diameter than the reference gearing 61 below. In particular, it is conceivable to provide an additional linear displacement axis for this purpose, with which the base element 110 can be displaced along a radial direction with respect to the workpiece axis relative to the machine bed.

Workpiece with One External Gearing and One Internal Gearing

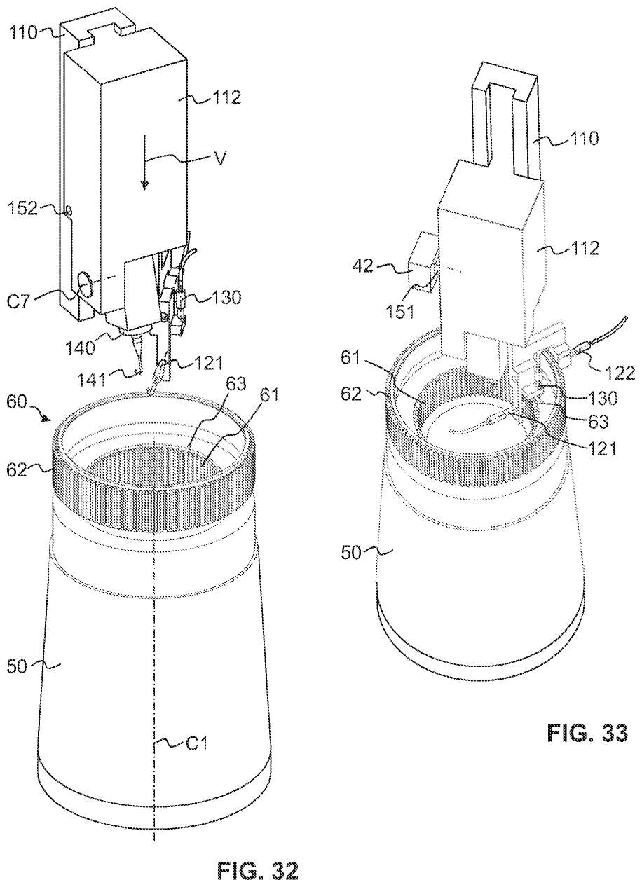

FIGS. 32 and 33 show a positioning device according to a tenth embodiment. Components with the same or similar function are again marked with the same reference signs as in FIGS. 1 to 6. This positioning device is configured to determine a reference rotational angular position of a double-gearing workpiece 60, whose reference gearing 61 is an internal gearing and whose gearing 62 to be machined is an external gearing.

The positioning device of the tenth embodiment is very similar to the positioning device of the ninth embodiment. The only significant difference is that the meshing sensor 122 is now radially inwardly aligned to measure the gearing 62 to be machined.

Use in a Gear Skiving Machine

In some embodiments, the positioning device can be attached to a component of a machine tool that can be moved relative to the workpiece by machine axes that are present anyway. In particular, the positioning device can be mounted on a movable tool carrier of the machine tool, the tool carrier carrying the tool spindle.

This is illustrated in FIGS. 34 and 35. These figures show a gear skiving (hob peeling) machine constructed according to the international patent application PCT/EP 2020/068945 of Jul. 6, 2020 and carrying a positioning device according to an eleventh embodiment. The contents of the international patent application PCT/EP 2020/068945 of Jul. 6, 2020 are incorporated by reference into the present disclosure.

The machine has a machine bed 310, The machine bed 310 is approximately L-shaped in side elevation, with a horizontal section 311 and a vertical section 312.

A movable workpiece carrier in the form of a Y-slide 340 is arranged on the horizontal section 311. The Y-slide 340 can be moved along a Y-direction relative to the machine bed 310. The Y-direction runs horizontally in space. The Y-slide 340 carries a workpiece spindle 50 on which a pre-toothed workpiece 60 is clamped. Workpiece 60 is rotated on workpiece spindle 50 around a workpiece axis (C-axis). The C-axis runs vertically in space. In this example, workpiece 60 has two internal gearings, namely a reference gearing 61 and a gearing to be machined 62 arranged above it.

A Z-slide 320 is arranged at the vertical section 312 of the machine bed 310. It can be moved along a vertical Z-direction relative to the machine bed 310, A tool carrier in the form of an X-slide 322 is arranged on the Z-slide 320. The X-slide carries a tool spindle 30. The X-slide 322 can be moved along an X-direction relative to the Z-slide 320, The X-direction runs horizontally in space and perpendicular to the Y- and Z-direction. Together, the Z-slide 320 and the X-slide 322 form a cross slide that enables the tool spindle 30 mounted on it to be moved along the Z- and X-directions, which are perpendicular to each other.

The tool spindle 30 drives a gear skiving tool clamped on it to rotate around a tool axis. In FIGS. 34 and 35, the gear skiving tool is hidden by the X-slide 322 and therefore not visible. The tool spindle 30 can be swiveled relative to the X-slide 322 about a horizontal swivel axis (A-axis) running parallel to the X-direction.

The X-slide 322 also carries the positioning device 100, which is shown enlarged in FIG. 35. The positioning device comprises a base element 110 and a sensor carrier 112 that can be moved along a displacement direction V. The displacement direction V is oblique to the Y- and Z-directions and perpendicular to the X-direction. Using the machine axes X, Y, and Z and the displacement axis V, the sensor carrier 112 can be brought into the measuring position shown in FIGS. 34 and 35.

In this way it is possible in particular to bring the sensor carrier 112 into the measuring position without collision even if the gearing 62 to be machined has a smaller inner diameter than the reference gearing 61.

The positioning device 100 is mounted in an area of the X-slide 322 that is sufficiently far away from the gear skiving tool that the positioning device 100 does not interfere with it during the machining of the workpiece 60.

Position Reference Device

In all the exemplary embodiments explained above, a position reference device may be used to determine the spatial position of the positioning device relative to the workpiece carrier. While in some of the exemplary embodiments explained above, a position reference device is shown which comprises only a tangential position sensor, the position reference device may also comprise position reference sensors with respect to other spatial directions.

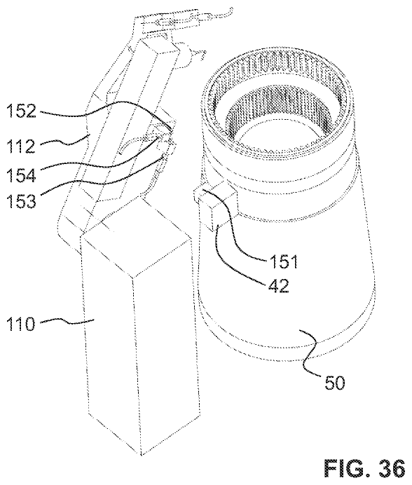

This is illustrated in FIG. 36, which shows a positioning device according to a twelfth embodiment. The positioning device of FIG. 36 corresponds essentially to the positioning device of the eighth embodiment. It only differs in the design of the position reference device.

In this embodiment, the position reference device again comprises a position reference target 151 on a reference carrier 42. The position reference target 151 is cuboidal or cubic and forms at least three reference surfaces perpendicular to each other. The reference carrier 42 is rigidly connected to the workpiece carrier carrying the workpiece spindle 50. Three position reference sensors 152, 153 and 154 are now arranged on the sensor carrier 112. In the measuring position, these are directed toward different reference surfaces of the position reference target 151. A first position reference sensor 152 forms a tangential position sensor. This sensor is directed toward a corresponding reference surface of the position reference target 151 along a direction that runs tangential to the workpiece, the reference surface having a tangential surface normal. A second position reference sensor 153 forms an axial position sensor. This sensor is directed toward a corresponding reference surface of the position reference target 151 along a direction that is parallel to the workpiece axis, the reference surface having an axially running surface normal. A third position reference sensor 154 forms a radial position sensor. This sensor is directed toward a corresponding reference surface of the position reference target 151 in a direction that runs radially to the workpiece axis, the reference surface having a radially running surface normal. Instead of a single position reference target with several reference surfaces, several position reference targets can also be present, each of these position reference targets forming a corresponding reference surface for one of the measuring directions.

The roles of the position reference sensors 152, 153, 154 and the position reference target 151 can also be reversed, i.e. the position reference sensors can be located on the reference carrier and the position reference target can be located on the sensor carrier.

The position reference sensors are preferably laser distance sensors, as they are known from the prior art per se.

Modifications

While the invention has been explained by means of several exemplary embodiments, the invention is not limited to these embodiments, and a large number of modifications are possible. Some modifications have already been described above. The invention is not limited to the application within the scope of the above mentioned exemplary gear cutting processes such as gear grinding or gear skiving. Rather, it is also possible to use the invention within the scope of other fine machining processes of double and multiple gears. These can be, for example, other gear machining processes such as gear honing or discontinuous processes such as profile grinding. If the sensor carrier is pivotably connected to a base element, the swivel axis can be not only horizontal or vertical, but also inclined in space. If the sensor carrier is linearly displaceable with respect to the base element, the direction of displacement can deviate from the insertion direction of the probe tip, as is the case in some of the embodiments explained above. A curved displacement direction along an arc is also conceivable. In all embodiments it is conceivable to use another type of marking instead of a hole and to place it at a different position than shown. Accordingly, another type of marking sensor can be used, which is adapted to the type of marking, and the marking detection device can be connected to the sensor carrier in a different way. A variety of other modifications are possible.

### LIST OF REFERENCE SIGNS

10 Machine bed
20 Tool carrier
21 Z slide
22 Y-slide
30 Tool spindle
31 Grinding worm
32 Tool spindle drive
40 Turret/workpiece carrier
42 Reference carrier
50 Workpiece spindle
51 Counter column
52 Tailstock
60 Workpiece
61 First gearing (reference gearing)
62 Second gearing (gearing to be machined)
63 Marking (bore/hole)
70 Machine controller
71 Control module
72 Control panel
100 Positioning device
110 Base element
112 Sensor carrier
121 First meshing sensor
122 Second meshing sensor
130 Marking detection device
131 (First) marking sensor
132 Second marking sensor
140 Reference measuring device (tactile sensor)
141 Probe tip
142 Linear slide
151 Position reference target
152 Tangential position sensor
153 Radial position sensor
154 Axial position sensor
210 Signal of the first marking sensor
211 Peak
220 Signal of the second marking sensor
230 Difference signal
231 Position signal
301 Reference tooth gap
302 Corresponding tooth gap
310 Machine bed
311 Horizontal section
312 Vertical section
320 Z-slide
322 X-slide/tool carrier
340 Y-slide workpiece carrier
C, C1 Workpiece axis
C3 Swivel axis of turret
C5 Horizontal swivel axis
C6 Vertical swivel axis
C7 Horizontal swivel axis
E Insertion direction
M Marking detection direction
R Radial measuring direction
T Tangential direction
V Displacement direction
X, Y, Z Linear axes

1. A method of machining a workpiece having first and second gearings, the workpiece being mounted for rotation about a workpiece axis, the method comprising:
identifying at least one reference tooth structure of the first gearing with a reference identification device operating without contact;
measuring the at least one reference tooth structure with a reference measuring device to determine a reference rotational angular position of the workpiece; and
machining the second gearing with a machining tool in such a way that the second gearing obtains a rotational angular position that is in a predetermined relationship to the determined reference rotational angular position.

2. The method according to claim 1, wherein the workpiece comprises a marking, wherein the reference identification device comprises a marking detection device operating without contact, and wherein identifying the at least one reference tooth structure of the first gearing comprises:
detecting the marking of the workpiece with the marking detection device; and
identifying the at least one reference tooth structure of the first gearing by means of the detected marking.

3. The method according to claim 2, wherein the marking detection device comprises first and second marking sensors, wherein detecting the marking comprises forming a difference of signals from the first and second marking sensors.

4. The method according to claim 1, wherein the reference identification device comprises a non-contact first meshing sensor and a non-contact second meshing sensor, and wherein identifying the at least one reference tooth structure of the first gearing comprises:
determining rotational angular positions of tooth structures of the first gearing with the first meshing sensor;
determining rotational angular positions of tooth structures of the second gearing with the second meshing sensor;
determining rotational angular distances of tooth structures of the first gearing to tooth structures of the second gearing from the determined rotational angular positions; and
identifying the at least one reference tooth structure of the first gearing on the basis of a comparison of the rotational angular distances with a specified nominal distance.

5. The method according to claim 1, wherein the reference measuring device comprises
a tactile sensor.

6. The method according to claim 5,
wherein the tactile sensor comprises a sensor base and a probe tip, and
wherein the probe tip is extended relative to the sensor base to be brought into engagement with the first gearing along an insertion direction.

7. The method according to claim 1, wherein the second gearing is machined by a generating machining process, and wherein a rolling coupling angle for the generating machining process is determined using the previously determined reference rotational angle position of the workpiece.

8. The method according to claim 1, comprising:
testing the first gearing with a non-contact first meshing sensor while the workpiece rotates about the workpiece axis; and/or
testing the second gearing with a non-contact second meshing sensor while the workpiece rotates about the workpiece axis.

9. The method according to claim 1, wherein the reference measuring device is mounted on a sensor carrier, and wherein the method comprises
moving the sensor carrier between a parking position and a measuring position.

10. The method according to claim 9, wherein at least part of the reference identification device is attached to the sensor carrier.

11. The method according to claim 9, comprising:
determining a position of the sensor carrier in the measuring position with respect to at least one spatial direction, using a position reference device; and
correcting the determined reference rotational angular position using the determined position of the sensor carrier.

12. The method according to claim 1,
wherein the first gearing and the second gearing are external gearings;
wherein the first gearing and the second gearing are internal gearings;
wherein the first gearing is an internal gearing and the second gearing is an external gearing; or
wherein the first gearing is an external gearing and the second gearing is an internal gearing.

13. A positioning device for determining a reference rotational angular position of a workpiece having first and second gearings, the positioning device comprising:
a reference identification device configured to identify at least one reference tooth structure of the first gearing without contact; and
a reference measuring device configured to measure the reference tooth structure of the first gearing identified by the reference identification device to determine the reference rotational angular position of the workpiece.

14. The positioning device according to claim 13, wherein the reference identification device comprises a marking detection device configured to detect a marking of the workpiece without contact.

15. The positioning device according to claim 14, wherein the marking detection device comprises first and second marking sensors, the first and second marking sensors being arranged sequentially or side by side with respect to a circumferential direction of the workpiece.

16. The positioning device according to claim 13, wherein the reference identification device comprises:
a non-contact first meshing sensor for determining rotational angular positions of tooth structures of the first gearing; and
a non-contact second meshing sensor for determining rotational angular positions of tooth structures of the second gearing.

17. The positioning device according to claim 16, wherein the first meshing sensor and/or the second meshing sensor are arranged offset from the reference measuring device along a circumferential direction of the workpiece.

18. The positioning device according to claim 13, wherein the reference measuring device comprises
a tactile sensor.

19. The positioning device according to claim 18,
wherein the tactile sensor comprises a sensor base and a probe tip, and
wherein the probe tip is extendable relative to the sensor base to be engaged with the first gearing along an insertion direction.

20. The positioning device according to claim 13, comprising a sensor carrier to which the reference measuring device is attached.

21. The positioning device according to claim 20,
wherein the reference measuring device comprises a tactile sensor,
wherein the tactile sensor is displaceably or pivotably arranged on the sensor carrier to bring the tactile sensor into engagement with the first gearing.

22. The positioning device according to claim 20, wherein at least part of the reference identification device is attached to the sensor carrier.

23. The positioning device according to claim 20, wherein the sensor carrier is movably connected to a base element in order to move the sensor carrier between a parking position and a measuring position.

24. The positioning device according to claim 23, further comprising a position reference device for determining a position of the sensor carrier in the measuring position with respect to at least one spatial direction.

25. A machine tool, comprising:
a workpiece carrier;
at least one workpiece spindle arranged on the workpiece carrier and configured to receive a workpiece having first and second gearings for rotation about a workpiece axis; and
a positioning device for determining a reference rotational angular position of the workpiece, the positioning device comprising a reference identification device configured to identify at least one reference tooth structure of the first gearing without contact, and a reference measuring device configured to measure the reference tooth structure of the first gearing identified by the reference identification device to determine the reference rotational angular position of the workpiece.

26. The machine tool according to claim 25,
wherein the positioning device comprises a sensor carrier to which the reference measuring device is attached,
wherein the sensor carrier is movably connected to a base element in order to move the sensor carrier between a parking position and a measuring position,
wherein the positioning device comprises a position reference device for determining a position of the sensor carrier in the measuring position with respect to at least one spatial direction,
wherein the position reference device comprises at least one position reference target and at least one position reference sensor,
wherein either the at least one position reference target is connected to the workpiece carrier and the at least one position reference sensor is connected to the sensor carrier, or the at least one position reference target is connected to the sensor carrier and the at least one position reference sensor is connected to the workpiece carrier.

27. The machine tool according to claim 25,
comprising a machine bed, wherein the workpiece carrier is movable relative to the machine bed,
wherein the positioning device comprises a sensor carrier to which the reference measuring device is attached,
wherein the sensor carrier is movably connected to a base element in order to move the sensor carrier between a parking position and a measuring position, and
wherein the base element is arranged on the machine bed.

28. The machine tool according to claim 25,
wherein the workpiece carrier is pivotable relative to the machine bed about a workpiece carrier axis,
wherein the positioning device comprises a sensor carrier to which the reference measuring device is attached, and
wherein the sensor carrier is arranged on the workpiece carrier in a region located radially between the workpiece carrier axis and the workpiece axis.

29. The machine tool according to claim 25, further comprising:
a tool spindle configured to receive a machining tool for rotation about a tool axis; and
a control device configured to perform a method of machining the workpiece when the workpiece is mounted for rotation about the workpiece axis, the method comprising:
identifying the at least one reference tooth structure of the first gearing with the reference identification device;
measuring the at least one reference tooth structure with the reference measuring device to determine a reference rotational angular position of the workpiece; and
machining the second gearing with the machining tool in such a way that the second gearing obtains a rotational angular position that is in a predetermined relationship to the determined reference rotational angular position.

30. The method according to claim 1, wherein the reference measuring device comprises an optical sensor.

31. The positioning device according to claim 13, wherein the reference measuring device comprises an optical sensor.
